(19) United States
(12) Patent Application Publication
(10) Pub. No.: US 2025/0048519 A1
(43) Pub. Date: Feb. 6, 2025

(54) Synchronization of LED Indications

(71) Applicant: Mellanox Technologies, Ltd., Yokneam (IL)

(72) Inventors: Ofer Levy, Kiryat Ono (IL); Peled Dadosh, Kfar Saba (IL); Zachy Haramaty, Ramat Gan (IL); Avi Shalom, Givatayim (IL); Shir Leibovitz, Kfar Saba (IL)

(21) Appl. No.: 18/361,970

(22) Filed: Jul. 31, 2023

(51) Int. Cl. H05B 47/155

(52) U.S. Cl. CPC H05B 47/155

(57) ABSTRACT

A network device includes a plurality of ports, a plurality of optical indicators, two or more packet processing circuits, and synchronization circuitry. The two or more packet processing circuits are to process packets communicated over the ports, each packet processing circuit to control a subset of the optical indicators to display status information relating to a subset of the ports. At least some of the status information is represented by blinking of the optical indicators. The synchronization circuitry is to synchronize at least one operational characteristic of the optical indicators among the two or more packet processing circuits.

### FIELD OF THE INVENTION

The present invention relates generally to network communication systems, and, particularly to synchronization of visual activity indications in network devices.

### BACKGROUND OF THE INVENTION

Network devices such as switches, routers, hubs, etc. often comprise visual indications, e.g., a series of light-emitting diodes (LEDs), allowing an operator to efficiently monitor the operation of the network device.

An example can be found in “NVIDIA Spectrum-3 SN4000 1U and 2U Switch Systems Hardware User Manual” (revision 1.9, Jul. 24, 2022), LED Notifications chapter, which describes the LED notifications of the SN4000 switch, including system status, fan status, power supply status, unit identification and port status notifications.

### SUMMARY OF THE INVENTION

An embodiment of the present invention that is described herein provides a network device including a plurality of ports, a plurality of optical indicators, two or more packet processing circuits, and synchronization circuitry. The two or more packet processing circuits are to process packets communicated over the ports, each packet processing circuit to control a subset of the optical indicators to display status information relating to a subset of the ports. At least some of the status information is represented by blinking of the optical indicators. The synchronization circuitry is to synchronize at least one operational characteristic of the optical indicators among the two or more packet processing circuits.

In some embodiments, the synchronization circuitry includes a synchronization source circuit, to generate a synchronization indication and to synchronize the at least one operational characteristic of the optical indicators by sending the synchronization indication to the packet processing circuits.

In an example embodiment, the synchronization source circuit is connected to the packet processing circuits, directly or indirectly, by two or more buses, and the synchronization source circuit is to send the synchronization indication to the packet processing circuits by sending bits indicative of the synchronization indication over the buses. In an embodiment, the two or more buses are serial buses. In an embodiment, the serial buses have a clock rate not exceeding 1 MHz.

In a disclosed embodiment, the synchronization circuitry further includes at least one intermediary circuit, which (i) is connected to the synchronization source circuit by one of the serial buses, (ii) is connected to one or more of the packet processing circuits, directly or indirectly, by one or more additional serial buses, and (iii) is to relay the synchronization indication from the synchronization source circuit to the one or more of the packet processing circuits by sending one or more bits indicative of the synchronization indication over the one or more additional serial buses. In an embodiment, the one or more additional serial buses have a clock rate not exceeding 1 MHz.

In some embodiments, the synchronization circuitry is to synchronize a phase of the blinking among the two or more packet processing circuits. Additionally or alternatively, the synchronization circuitry is to synchronize a frequency of the blinking among the two or more packet processing circuits. Further additionally or alternatively, the synchronization circuitry is to synchronize a duty-cycle of the blinking among the two or more packet processing circuits.

There is additionally provided, in accordance with an embodiment of the present invention, a method in a network device that includes a plurality of optical indicators. The method includes processing packets communicated over a plurality of ports using two or more packet processing circuits, each packet processing circuit controlling a subset of the optical indicators to display status information relating to a subset of the ports. At least some of the status information is represented by blinking of the optical indicators. At least one operational characteristic of the optical indicators is synchronized among the two or more packet processing circuits.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a network device, in accordance with an embodiment of the present invention;

FIG. 2 is a block diagram that schematically illustrates a LED control circuit in a Packet Processing Circuit (PPC), in accordance with an embodiment of the present invention;

FIG. 3 is a block diagram that schematically illustrates hierarchical propagation of a synchronization indication signal in a Network Device, in accordance with an embodiment of the present invention;

FIG. 4 is a block diagram that schematically illustrates the structure of a synchronous bus data packet, in accordance with an embodiment of the present invention;

FIG. 5 is a block diagram that schematically illustrates a shift-register-to-shift-register serial link, in accordance with an embodiment of the present invention; and

FIG. 6 is a flowchart that schematically illustrates a method for synchronizing LED blinking in a network device, in accordance with an embodiment of the present invention.

### DETAILED DESCRIPTION OF EMBODIMENTS

### Overview

Network devices such as switches sometimes comprise a plurality of packet processing circuits (PPCs) that are connected to the network through network ports. The PPCs are mounted in the same mechanical enclosure, and may share, for example, power supplies, fans, and various indications.

The indications, comprising, for example, an array of Light Emitting Diodes (LEDs), are typically driven by the PPCs and indicate the status of the network ports.

For example, in some embodiments, the LEDs may indicate as follows:

| | | |
|---|---|---|
| Green LED | On: physical link | Off: physical link |
| | detected | not detected |
| Amber LED | Blinking: data | On or Off - no data |
| | transfer in progress | transfer activity |

Additionally, or alternatively, other suitable conventions may be used to indicate various states, conditions, events and/or activities.

A human operator who inspects the LEDs can, in a single fast glance, verify that a network device operates normally. This is especially important in large switching centers (e.g., in datacenters) that host rows of full-height racks, each comprising a plurality of PPCs.

The ability to verify, in a single glance, that a PPC operates normally, may be impeded When LED indications pertaining to two or more PPCs share the same panel, and the LEDs blink asynchronously (e.g., not in the same phase, the same frequency or the same duty cycle). Moreover, observing rows of LEDs that do not blink in unison, for an extended time period, may have an attrition effect. The human brain has a natural inclination to detect patterns and rhythms. Disruptions to these patterns can affect cognitive processes. Research on cognitive performance and visual distractions has shown that inconsistent visual stimuli can impair attention, concentration, and mental workload.

Embodiments of the present invention that are disclosed herein provide for circuits and methods to synchronize operational characteristics of optical indicators, e.g., of status LEDs, in a network device. In the present context, the term “operational characteristic” refers to various characteristics that define the blinking of the optical indicators. Examples of operational characteristics include the phase, frequency and duty-cycle of the blinking. The embodiments described herein refer mainly to synchronizing the blinking phase, by way of example.

In an embodiment, the network device comprises synchronization source circuitry that generates synchronization indication signals (e.g., pulses), and forwards the synchronization indication signals to the PPCs, which, then, synchronize the LED blinking to the synchronization indication signal. In an embodiment, the synchronization indication signal is a PPS (Pulse Per Second) pulse.

In some embodiments, the synchronization indication signal is sent to the PPCs over a synchronous serial bus; in an embodiment, the synchronization indication signal is sent hierarchically, from the synchronization source circuit to intermediate circuitry, and, thence, through shift-register to shift-register communication, to the PPCs.

### System Description

In embodiments, a Network Device comprises a plurality of PPCs that are connected to respective groups of Status LEDs (each group of Status LEDs comprising a plurality of LEDs) and a central synchronization circuit that sends a synchronization indication signal to the PPCs. The PPCs then drive the Status LEDs synchronously to each other.

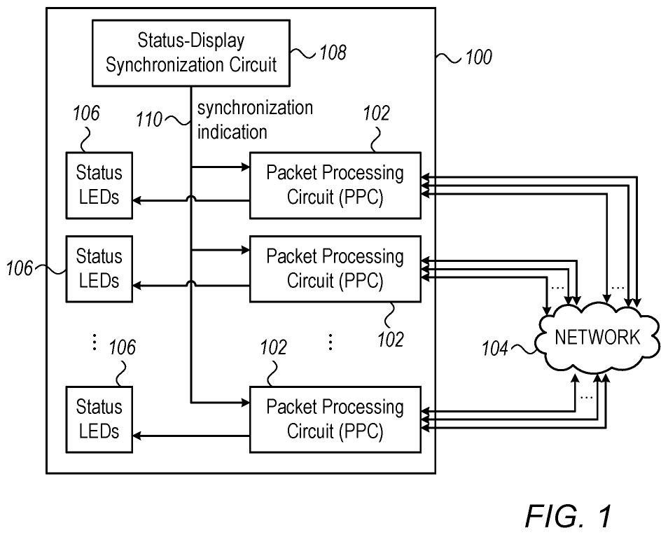

FIG. 1 is a block diagram that schematically illustrates a network device 100, in accordance with an embodiment of the present invention. The network device comprises multiple Packet Processing Circuits (PPCs) 102 that are configured to communicate packets over a packet network 104. Each PPC communicates with the network through one or more communication ports.

The PPCs are coupled to Status LEDs 106; each group of Status LEDs 106 may comprise a plurality of LED indicators, e.g., one LED for every communication port. The PPC drives the LEDs with an operating voltage (for a solid-on indication), a non-operating voltage (for a solid-off indication) or a pulse train (for blinking indication).

To synchronize the blinking of the LEDs, device 100 further comprises a Status-Display Synchronization Circuit 108, also referred to as “synchronization circuitry” for brevity, which is configured to send a Synchronization Indication signal 110 to PPCs 102. In an embodiment, the synchronization indication signal is a PPS (Pulse-Per-Second) signal, that pulses at a 1 Hz frequency. In other embodiments, other suitable frequencies may be used. In some embodiments, the synchronization indication signal may be implemented as a bit sent over a bus that is configured to transfer other information besides the synchronization indication signal.

The PPCs synchronize the phase of the blinking of the LEDs to the synchronization indication signal. In the present context, synchronizing the phase of the blinking means starting the “on” times of the blinking at the same time. In some embodiments, the PPCs comprise a counter-timer that times the blinking, and may, for example, generate several blinking rates. the PPC synchronizes the timer-counter responsively to the synchronization indication signal.

The configuration of network device 100 illustrated in FIG. 1 and described hereinabove is cited by way of example. Other configurations may be used in alternative embodiments. For example, in some embodiments, the synchronization indication signal is a square wave (e.g., with 50% duty cycle) that is gated by a Blink indication in the PPC and then directly drives the LEDs. In an embodiment, there are three synchronization indication signals at three different rates, gated by a Fast-Blink, a Medium-Blink and a Slow-Blink indications and then directly drive the status LEDs. In another embodiment, the synchronization indication signal is gated at the PPC and then directly drives the LEDS; thus, the synchronization indication signal may synchronize the blinking frequency and/or the blinking duty cycle.

In some embodiments, the Status LEDS comprises a LED driving circuitry; the PPC sends a digital indication code to the Status LEDS, which are also coupled to the synchronization indication signal, and drive the LEDS synchronously, according to the code, thereby causing all status LEDS to blink with the same phase, frequency and duty cycle.

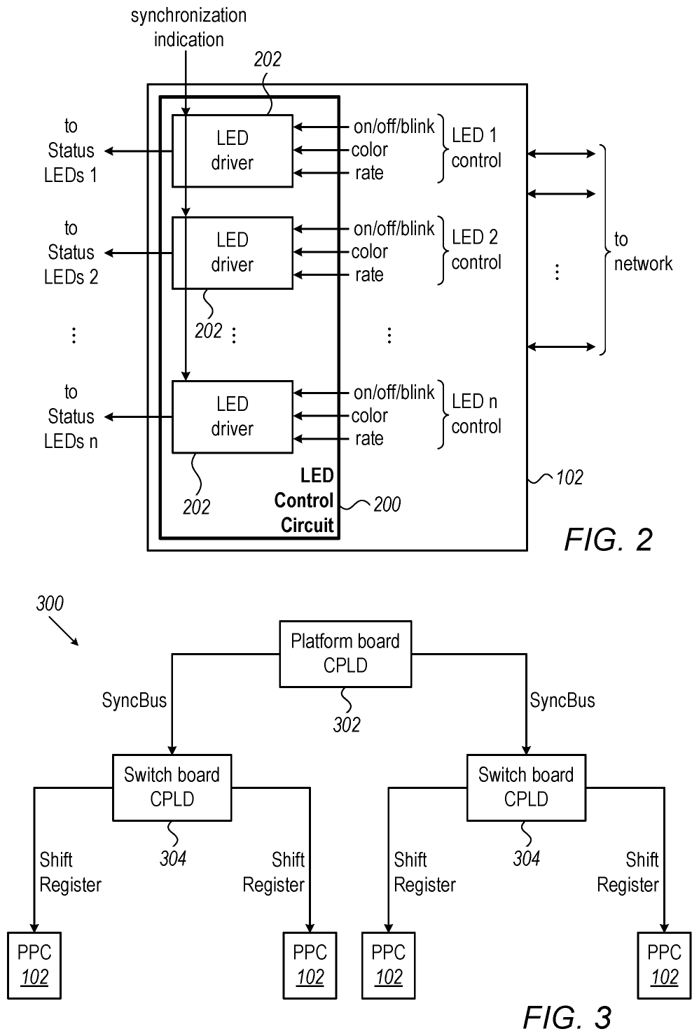

FIG. 2 is block diagram that schematically illustrates a LED control circuit 200 in a Packet Processing Circuit (e.g., PPC 102 of FIG. 1), in accordance with an embodiment of the present invention. The LED control circuit receives the synchronization indication signal (e.g., from Status-Display Synchronization Circuit 108, FIG. 1) and an LED control code for each of the LEDs in status-LEDs 106. The LED control code specifies, for the respective LED, whether the LED should be on, off or blinking, what is the blinking rate and what is the LED color (if applicable).

The LED Control circuit 200 comprises, for every controlled LED, a LED Driver 202, which receives a LED control input and the synchronization indication input, and, responsively, outputs a drive voltage or a drive pulse train to the respective LED (for bi color LEDs, the LED driver may output two signals, one for each color).

LED Driver 202 is configured to synchronize a pulse train to the synchronization indication signal. Thus, all blinking LEDs in all Status LEDs 106 will start a blink on-period at the same time, reducing operators' eye fatigue and increasing their efficiency.

The configuration of Led Control Circuit 200 illustrated in FIG. 2 and described hereinabove is cited by way of example. Other configurations may be used in alternative embodiments. For example, in some embodiments there is only one blinking rate; in an embodiment, there is only one LED color, and in another embodiment, there are more than two LED colors. In yet another embodiment the blinking rate may change, but all LEDs that are controlled by a given PPC blink at the same rate (in this case, the LED Control Circuit comprises a single Rate input).

### Sending the Synchronization Indication on a Bus

In some embodiments, network device 100 comprises an interconnect bus that connects some or all the PPCs. The synchronization indication may be sent, in this case, over the interconnect bus. In an embodiment, the interconnect bus is serial. In some embodiments, the synchronization indication propagates through a hierarchy of buses.

FIG. 3 is a block diagram that schematically illustrates hierarchical propagation of a synchronization indication signal in a Network Device 300, in accordance with an embodiment of the present invention. Network Device 300 comprises four PPCs 102 that communicate packets of a network (not shown).

The network device further comprises a Platform Board Complex Programmable Logic Device (CPLD) 302 that is configured to send data over a synchronous bus (referred to as SyncBus) to Switch Board CPLDs 304 (also referred to as intermediary circuit), and thence, over a shift-register-to-shift-register serial link to the PPCs. The SyncBus comprises various data fields for various indications. The Platform Board CPLD generates the synchronization indication and sends the indication in a preset field within the SyncBus data. In an example embodiment, the synchronization indication is always at the n^{th} bit position of the SyncBus data packets.

The data packet that comprises the synchronization indication is a broadcast packet that is sent to all destinations (PPCs). Switch Board CPLDs 304 are configured to send the data packets to the PPCs, using a shift-register-to-shift-register serial link (to be described below, with reference to FIG. 5).

In an example embodiment, the SyncBus and the shift-register-to-shift-register serial link each have a clock rate not exceeding (e.g., equal to) 1 MHz. Alternatively, however, any other suitable clock rates can be used. Further alternatively, a parallel bus can be used instead of a SyncBus, instead of a shift-register-to-shift-register serial link, or both.

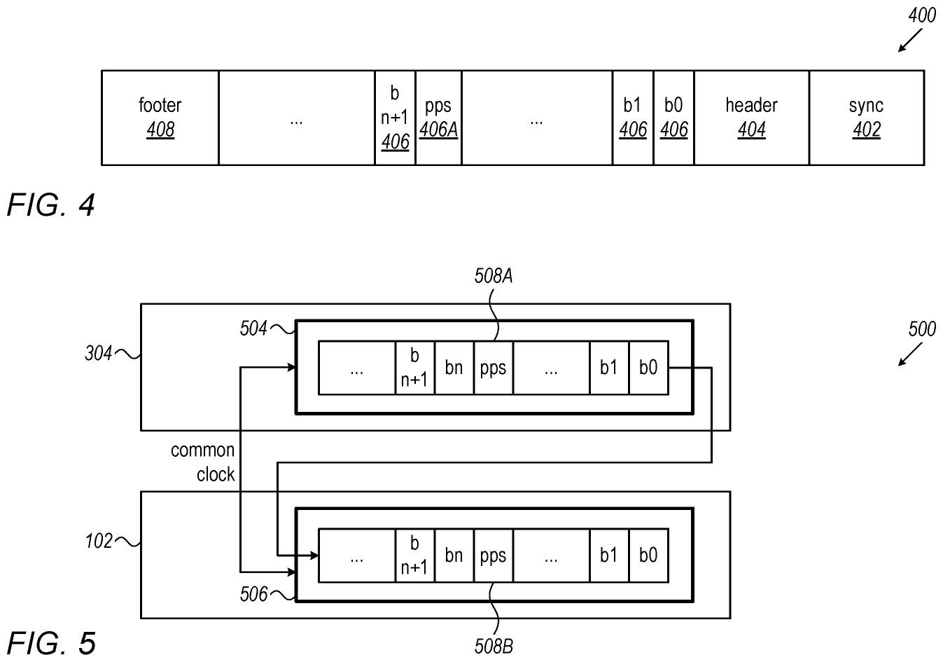

FIG. 4 is a block diagram that schematically illustrates the structure of a synchronous bus data packet 400, in accordance with an embodiment of the present invention. According to the example embodiment illustrated in FIG. 4, the synchronous bus is serial, comprising a Sync field 402, (e.g., to synchronize the sender and the receiver to the start of the transmission); a Header field 404 (e.g., to indicate a packet type, or a packet length); data bit fields 406; and a footer field 408 (e.g., a Cyclic Redundancy Check (CRC) code). Data bit fields 406 comprise bits in preset locations, including a PPS bit 406A, which comprises the synchronization indication that Platform Board CPLD 302 (FIG. 3) sends.

The structure of synchronous data bus packet 400 illustrated in FIG. 4 and described hereinabove is cited by way of example. Other packet structures may be used in alternative embodiments. For example, in some embodiments, there is no sync code; instead, the bus comprises an Enable signal that envelopes the data bits, or a start signal that signals the start of the data packet.

In embodiments, the packet structure does not include a footer, and in other embodiments the structure does not include a header.

FIG. 5 is a block diagram that schematically illustrates a shift-register-to-shift-register serial link 500, in accordance with an embodiment of the present invention. Serial link 500 shifts data from a source shift-register 504 (in Switchboard CPLD 304) to a destination shift-register 506 (in PPC 102), using a shared clock. The bits of the source shift-register, designated b0 through bn, are copied, after all bits are shifted, to respective bits in the destination shift-register, including a PPS indication bit 508A that is copied to a respective PPS indication bit 508B.

According to the example embodiment illustrated in FIG. 5, source shift-register 504 and destination shift-register 506 share the same clock; in embodiments, there may also be a start signal, indicating the start of the transfer, or, for example, an envelope signal, enveloping the transfer.

In embodiments, source shift-register 504 comprises a parallel-in input, and destination shift-register 506 has a parallel-out output.

### Synchronization Mismatch

The transmission of the synchronization indication in a serial bus adds latency; if the latency between PPCs is not equal, blinking synchronization mismatches may occur. However, assuming a 1 MHz SyncBus and shift-register clock rates, a mismatch of a thousand bits (for example), causes a 1 mS mismatch, which cannot be detected by the human eye.

Moreover, since the PPS bit is typically located in the same bit position (in both the SyncBus and the shift-register), the difference in latencies may narrow down to less than one bit time and, hence, no visual synchronization mismatch artifacts are expected.

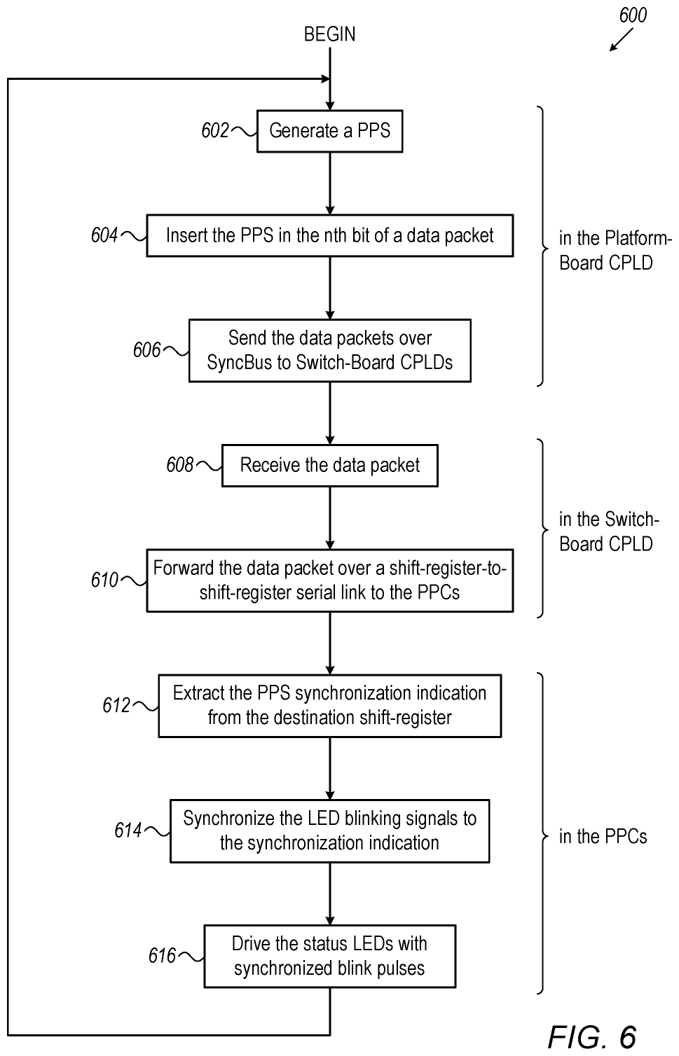

FIG. 6 is a flowchart 600 that schematically illustrates a method for synchronizing LED blinking in a network device. The flowchart is executed by Platform-Board CPLD 302 (FIG. 3), Switch-Board CPLD 304 (FIG. 3) and PPCs 102 (FIG. 1).

The flowchart starts at a Generate PPS operation 602, wherein the Platform-Board CPLD generates a synchronization indication PPS. Next, at an Insert PPS In Packet operation 604, the Platform-Board CPLD inserts the PPS indication in the n^{th} bit of a data packet. The Platform-Board CPLD will set the inserted bit to a first logic value (e.g., logic 1) if the PPS is on, and to a second logic value (e.g., logic 0) if the PPS is off.

The Platform-Board CPLD then, at a Send Packet over SyncBus operation 606, sends the data packet over the SyncBus to the Switch-Board CPLDs, and, at a Receive Packet from SyncBus operation 608, the Switch-Board CPLDs receives the packet from the SyncBus.

At a Shift-Register Send operation 610, the Switch Board CPLDs sends the received data packets, including the PPS bit, to the PPCs, using shift-register-to-shift-register communication (each Switch Board CPLD sends the data to one or more PPCs that are coupled to the Switch-Board CPLD).

At an Extract PPS Bit operation 612, the PPCs extract the PPS bit from the destination shift-register (the PPS bit is in a preset bit location) and then, at a Synchronize LED blinking operation 614, the PPCs synchronize the blinking to the PPS bit (e.g., if the PPS bit is at logic-1, the PPC will reset a timer-counter that start the blinking-on period).

Lastly, at a Drive Status LEDs operation 616, the PPCs drive the LEDs with a solid-on, solid-off or a synchronized blinking pulse-train (after operation 616, the flowcharts reenters operation 602, and, thus, the flowchart is in an infinite loop).

The configuration of flowchart 600 illustrated in FIG. 6 and described hereinabove is cited by way of example. Other flowcharts may be used in alternative embodiments. For example, in an embodiment, the SyncBus is wired directly to the PPCs, and no shift-register-to-shift-register communication is needed.

The configurations of Network Device 100, LED Control Circuit 200, Network Device 300, SyncBus Data Packet 400, Serial Link 500, and the method of flowchart 600, illustrated in FIGS. 1 through 6 and described hereinabove, are example configurations and flowcharts that are shown purely for the sake of conceptual clarity. Any other suitable configurations and flowcharts can be used in alternative embodiments. The different sub-units of Network Device 300 may be implemented using suitable hardware, such as in one or more Application-Specific Integrated Circuits (ASICs) or Field-Programmable Gate Arrays (FPGAs) (including CPLDs), using software, using hardware, or using a combination of hardware and software elements.

Although the embodiments described herein mainly address synchronization of visual indications in a network device, the methods and systems described herein can also be used in other applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
a plurality of ports;
a plurality of optical indicators;
two or more packet processing circuits, to process packets communicated over the ports, each packet processing circuit to control a subset of the optical indicators to display status information relating to a subset of the ports, wherein at least some of the status information is represented by blinking of the optical indicators; and
synchronization circuitry, to synchronize at least one operational characteristic of the optical indicators among the two or more packet processing circuits.

2. The network device according to claim 1, wherein the synchronization circuitry comprises a synchronization source circuit, to generate a synchronization indication and to synchronize the at least one operational characteristic of the optical indicators by sending the synchronization indication to the packet processing circuits.

3. The network device according to claim 2,
wherein the synchronization source circuit is connected to the packet processing circuits, directly or indirectly, by two or more buses, and
wherein the synchronization source circuit is to send the synchronization indication to the packet processing circuits by sending bits indicative of the synchronization indication over the buses.

4. The network device according to claim 3, wherein the two or more buses are serial buses.

5. The network device according to claim 4, wherein the serial buses have a clock rate not exceeding 1 MHz.

6. The network device according to claim 4, wherein the synchronization circuitry further comprises at least one intermediary circuit, which (i) is connected to the synchronization source circuit by one of the serial buses, (ii) is connected to one or more of the packet processing circuits, directly or indirectly, by one or more additional serial buses, and (iii) is to relay the synchronization indication from the synchronization source circuit to the one or more of the packet processing circuits by sending one or more bits indicative of the synchronization indication over the one or more additional serial buses.

7. The network device according to claim 6, wherein the one or more additional serial buses have a clock rate not exceeding 1 MHZ.

8. The network device according to claim 1, wherein the synchronization circuitry is to synchronize a phase of the blinking among the two or more packet processing circuits.

9. The network device according to claim 1, wherein the synchronization circuitry is to synchronize a frequency of the blinking packet processing circuits.

10. The network device according to claim 1, wherein the synchronization circuitry is to synchronize a duty-cycle of the blinking among the two or more packet processing circuits.

11. A method in a network device that includes a plurality of optical indicators, the method comprising:
processing packets communicated over a plurality of ports using two or more packet processing circuits, each packet processing circuit controlling a subset of the optical indicators to display status information relating to a subset of the ports, wherein at least some of the status information is represented by blinking of the optical indicators; and
synchronizing at least one operational characteristic of the optical indicators among the two or more packet processing circuits.

12. The method according to claim 11, wherein synchronizing the at least one operational characteristic comprises generating a synchronization indication and sending the synchronization indication to the packet processing circuits.

13. The method according to claim 12, wherein synchronizing the at least one operational characteristic comprises sending the synchronization indication to the packet processing circuits over two or more buses.

14. The method according to claim 13, wherein the two or more buses are serial buses.

15. The method according to claim 14, wherein the serial buses have a clock rate not exceeding 1 MHz.

16. The method according to claim 14, wherein synchronizing the at least one operational characteristic comprises relaying the synchronization indication to one or more of the packet processing circuits via at least one intermediary circuit, by sending one or more bits indicative of the synchronization indication over one or more additional serial buses.

17. The method according to claim 16, wherein the one or more additional serial buses have a clock rate not exceeding 1 MHZ.

18. The method according to claim 11, wherein synchronizing the at least one operational characteristic comprises synchronizing a phase of the blinking among the two or more packet processing circuits.

19. The method according to claim 11, wherein synchronizing the at least one operational characteristic comprises synchronizing a frequency of the blinking among the two or more packet processing circuits.

20. The method according to claim 11, wherein synchronizing the at least one operational characteristic comprises synchronizing a duty-cycle of the blinking among the two or more packet processing circuits.
